(19) United States
(12) Patent Application Publication
(10) Pub. No.: US 2005/0084146 A1
(43) Pub. Date: Apr. 21, 2005

(54) Map of a property

(76) Inventors: John Douglas Glenton Watson, Castlecrag (AU); Gary Francis Egan, North Keilor (AU); Nathan Brett Walters, Darlinghurst (AU); Mark Jenkinson, Kidlington (GB); Mostyn Bramley-Moore, Parkville (AU)

Correspondence Address: OSTROLENK FABER GERB & SOFFEN, 1180 AVENUE OF THE AMERICAS, NEW YORK, NY, 100368403, US

(21) Appl. No.: 10/480,080

(22) PCT Filed: Jun. 6, 2002
(86) PCT No.: PCT/AU02/00731

(30) Foreign Application Priority Data
Jun. 7, 2001 (AU) PR 5543

(51) Int. Cl. G06K 9/00; G01V 3/00

(52) U.S. Cl. 382/131; 324/307

(57) ABSTRACT

The present invention provides a method of mapping a property of a three dimensional object. The method comprises the steps of mapping the property for at least a portion of the object, providing a line or region which defines intersections with part of the mapped portion, and displaying the property for the intersections. The present invention also provides another method of mapping a property of an object. The method comprises the steps of mapping the property for a slice within the object, providing a line within the slice, and displaying the property for the line.

### FIELD OF THE INVENTION

The present invention relates to a method of creating a map of a property of an object and to a map when created in accordance with the method. The invention relates particularly, though not exclusively, to a method of creating a map of a property derived from nuclear magnetic resonances related to a line or region within an object.

### BACKGROUND OF THE INVENTION

It is currently of significant interest in different areas of research and analysis, in particular in medicine, to obtain non-destructively images or line-scans related to regions within objects. Typical objects may include biological specimen such as live human brains. The analysis of such images or line-scans may reveal information that is essential for understanding the functional organisation of the human brain.

In order to gain a more detailed understanding of the activation of the cerebral cortex of the brain, the anatomical organisation of the brain has to be known. With regard to the cerebral cortex, which is of particular interest in studies of cognition, a key question is how one relates the results of a functional neuro-imaging study with particular cortical areas in which changes in neural activity occur.

An enormous and costly effort is expended in carrying out functional neuro-imaging of ever increasing resolution, but in the end the researcher is left with only a crude anatomical estimate of the activated cortical areas. If this situation is to be resolved, better human brain atlases are required. However, these suffer from one major problem; namely inter-subject variations in brain micro- and macrostructure.

Histological examination of the cyto-architecture, myelo-architecture and chemo-architecture of the brain remains the best method of accurately defining anatomically distinct regions. Ideally, if this can be performed in every subject used in functional neuroimaging studies, each individual's functional results can be precisely and accurately related with their own anatomical brain map. Furthermore, if a functionally active cortical focus were consistently found to be correlated with a well defined anatomical region across a population of subjects, this would significantly advance understanding of human brain organisation. Obviously, this is not practical except in a few rare cases. Instead, the results from postmortem brains of “non-subjects” in functional studies are used which again results in problems of inter-subject variability.

### SUMMARY OF THE INVENTION

According to a first aspect of the invention there is provided a method of mapping a property of a three dimensional object, said method comprising the steps of
mapping the property for at least a portion of the object,
providing a line or region which defines intersections with part of said mapped portion, and
displaying the property for the intersections.

According to a second aspect of the invention there is provided a method of mapping a property of a three dimensional object, said method comprising the steps of:
mapping the property for a plurality of slices within the object,
providing a line or region which defines intersections with part of at least some of the plurality of slices, and
displaying the property for the intersections.

Preferably the property relates to nuclear magnetic resonances. More preferably, mapping of the property for the slices results in a plurality of nuclear magnetic resonance images.

It should be understood that nuclear magnetic resonances and nuclear magnetic resonance images are terms usually used by physicists and chemists. It is common practice to abbreviate these terms in a clinical environment to magnetic resonances and magnetic resonance images, respectively.

Preferably the line or region is a line. More preferably, the line is a plurality of lines.

Preferably, each of the lines is substantially perpendicular to the surface of the three-dimensional object.

In one embodiment the object is a biological object such as the brain of a subject (or another organ of a human or animal, or a semi-biological or inanimate object) and each of the lines is a line through the cortex of the brain. The cortex of the human brain is convoluted and contains a plurality of grooves. Therefore, a line substantially perpendicular to the surface, for example within a groove, would typically intersect not only one slice, but can intersect a plurality of slices which are related to nuclear magnetic resonance images taken from adjacent areas of the brain.

Preferably, the method further comprises the steps of approximating the shape of the object by a three dimensional lattice of two-dimensional forms created by a first computer routine. More preferably, the lattice is a mesh.

Preferably, the lines are each substantially perpendicular to a respective one of the two-dimensional forms.

Preferably the intersections of each of the lines with each of the slices are selected using a second computer routine. More preferably a third computer routine maps nuclear magnetic resonance values for the intersections by displaying an array of values.

Preferably the method further comprises the step of analysing the array of values using a fourth computer routine. More preferably the fourth computer routine analyses quantitative properties.

Preferably analysing the array of values using the fourth computer routine comprises differentiation. More preferably analysing the array of values comprises determining the positions of the maxima, minima and/or zero-points of the array of values and the derivatives of the array of values.

In one embodiment, the positions of the inner and outer boundaries of the grey matter of the brain may be approximated by determining the positions of the maxima of the first derivative of the array of values. Two closely followed zero-points of the first derivative may indicate the presence of lamination. By measuring the relative positions of the zero points the thickness of the lamination can be determined.

According to a third aspect of the invention there is provided a map produced by a method of mapping a property of a three dimensional object, said method comprising the steps of:
mapping the property for at least a portion of the object,
providing a line or region which defines intersections with part of said mapped portion, and
displaying the property for the intersections.

According to a fourth aspect of the invention there is provided a map produced by a method of mapping a property of a three dimensional object, said method comprising the steps of:
mapping the property for a plurality of slices within the object,
providing a line or region which defines intersections with part of at least some of the plurality of slices, and
displaying the property for the intersections.

According to a fifth aspect of the invention there is provided a method of mapping a property of an object, said method comprising the steps of:
mapping the property for a slice within the object,
providing a line within the slice, and
displaying the property for the line.

Preferably the property relates to nuclear magnetic resonances. More preferably, mapping of the property for the slice results in a nuclear magnetic resonance image.

Preferably, the line is a plurality of lines. More preferably in the fourth aspect a computer routine maps nuclear magnetic resonance values for each of the lines by displaying an array of values.

In one embodiment the object is a biological object such as a brain and each of the lines is a line through the cortex of the brain.

Preferably the method further comprises the step of analysing the array of values using a fifth computer routine. More preferably the fifth computer routine analyses numerical properties.

Preferably analysing the array of values using the fifth computer routine comprises differentiation. More preferably analysing the array of values comprises determining the positions of the maxima, minima and/or zero-points of the array of values and the derivatives of the array of values.

In one embodiment, the positions of the inner and outer boundaries of the grey matter of the brain may be approximated by determining the positions of the maxima of the first derivative of the array of values. Two closely followed zero-points of the first derivative may indicate the presence of lamination. By measuring the relative positions of the zero points the thickness of the lamination can be determined.

According to a sixth aspect of the invention there is provided a map produced by a method of mapping a property of an object, said method comprising the steps of:
mapping the property for a slice within the object,
providing a line within the slice, and
displaying the property for the line.

### BRIEF DESCRIPTION OF THE DRAWINGS

Preferred embodiments of the invention will now be described, by way of example only, with reference to the accompanying drawings in which:

FIG. 1(a) shows a nuclear magnetic resonance image of a living human brain. The insert shows a typical line scan. FIG. 1(b) shows lamination within the image shown in FIG. 1 determined by a computer routine.

FIG. 2(i) shows a histological image of a section of a human brain (intensities changed), and the insert shows the original image. FIG. 2(ii) shows a nuclear magnetic resonance image corresponding to the histological image of FIG. 2(i). FIGS. 2(iiia) and 2(iiib) show histological profiles as indicated in FIG. 2(i). FIG. 2(iv) shows intensity line scans corresponding to regions indicated in FIG. 2(i) and FIG. 2(ii).

FIG. 3 shows a mesh of two-dimensional forms that approximates the shape of a human brain.

FIG. 4 shows the analysed nuclear magnetic resonance values in a three-dimensional visualisation. Darker regions indicate lamination.

FIG. 5 shows a MRI slice of cartilage from a human knee and the insert shows line scans along which analyses were conducted.

### DETAILED DESCRIPTION OF THE PREFERRED EMBODIMENTS

### EXAMPLE 1

### Two-Dimensional Semi-Automated Cortical Lamination Analysis

(Computer Codes Referred to Throughout This Example are Listed in the Appendix.)

High-resolution T1 nuclear magnetic resonance images (NMRI) of the brain with high signal, low signal-to-noise, and high grey/white and grey/grey matter contrast suitable for lamination analysis were obtained. In vivo studies were performed using a magnetic field of 1.5 T and post-mortem studies were performed at 4.7 T.

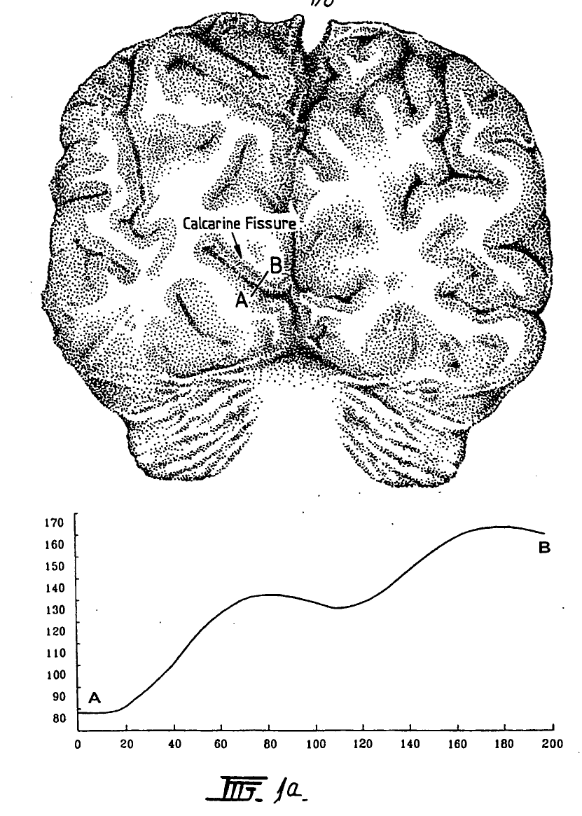

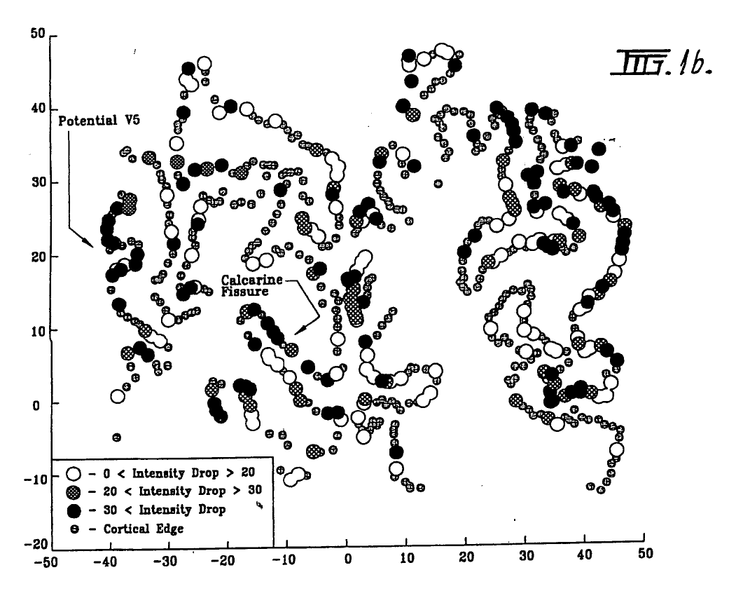

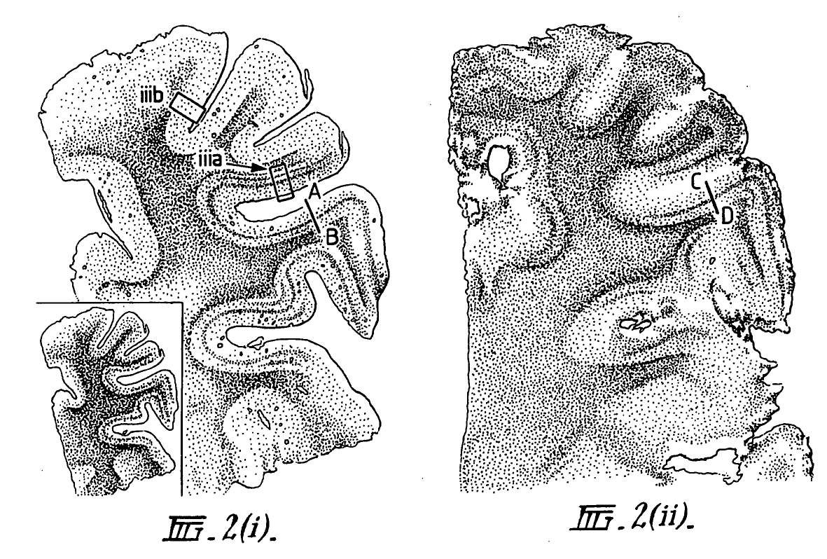

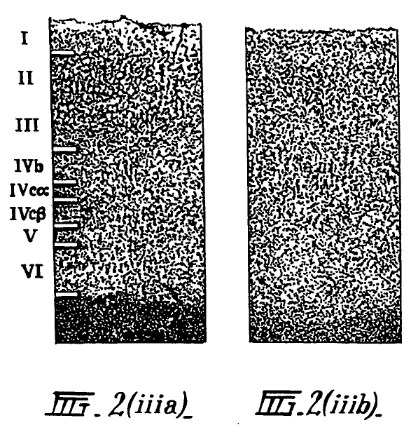

FIG. 1(a) shows a nuclear magnetic resonance image of living human brain. Eight T1 weighted spin echo images were acquired on a GE Signa NMRI scanner in a single session using a 7.5″ surface coil positioned at the occipital poles. These were aligned, re-sampled and averaged. This image shows evidence of the striate cortex within the calcarine fissure (arrow). [The parameters were: number of slices=148; slice thickness=0.700 mm; field of view (FOV)=16 cm²; matrix size=256×256; In-plane resolution 0.625 mm×0.625 mm; Echo Time (TE)=2.7 s; Repetition Time (TR)=12.4 s; Number of Excitations (NEX)=1; Flip Angle=25°; Inversion Time (TI)=350 ms] The insert of FIG. 2(i) snows a histological image of a section of a human brain and the expanded view shows the same image with changed intensities. FIG. 2(ii) shows a nuclear magnetic resonance image corresponding to the histological image of FIG. 2(i). [The parameters were: number of slices: 30; slice thickness: 1 mm (no gap); FOV: 8×4 cm2; matrix size: 512×256; in-plane resolution: 156 μm×156 μm; TE_{eff}=82.4 ms; TR=6 s; NEX=4; Acquisition Time (TA)=1 hr 42 min 24 s]. FIGS. 2(iiia) and 2(iiib) show histological profiles related to areas indicated in FIG. 2(i).

Once the images were acquired, they were analysed to determine cortical areas of lamination. This involves examining the intensity changes across the cortical grey matter in the images. It is known that the relative concentrations of myelin within cortical laminae can be directly measured in the striate cortex using high-resolution NMRI. Depending on the scanning protocol used, areas of myelination display either a dip or a peak in the intensity profile across that area of cortex.

To the analysis a series of intensity line profiles around the entire cortex are taken perpendicular to the cortical surface and through the grey matter. FIG. 2(iv) shows intensity line scans from corresponding regions of striate cortex in the histological slide 2(i) and the NMRI slice 2(ii) and the Insert of FIG. 1(a) shows a typical line profile showing a characteristic intensity drop. (“A” corresponds to a point just outside the cortical surface whilst “B” corresponds to a point just deep of the grey/white matter junction).

FIG. 1(b) shows lamination determined using the computer routine “corla”. This plot shows regions in which there is an intensity dip found within the line profile indicating a particular pattern of cortical lamination. Results were thresholded and grouped based on a measure of the noise from the average image found by calculating the standard deviation of the signal intensity from an apparently uniform area (the background). Large pale grey circles are those in which the intensity drop is between 1 and 2 standard deviations, large dark grey circles between 2 and 3, and black circles greater than 3.

The program “Corla” implements a two-dimensional, slice-by-slice method and requires as input a series of contiguous evenly spaced line profiles taken through the cortical grey matter, perpendicular to its surface. The main steps taken in the analysis consist of determining:
cortical boundaries: the air/cortical boundary and the grey/white matter boundary,
the presence or absence of cortical lamination evidenced by an internal intensity drop (ie a local intensity peak followed by a trough)—if present, the number, position, thickness and intensity drop for the lamina are calculated.

The results are represented as an array of coordinates along the cortical boundary each of which has assigned to it a series of values which characterise the line profile at that point through the grey matter normal to the surface. These results are then graphically represented for ease of interpretation.

1. Line Profiles

The lines were selected through the cortex and spaced as evenly as possibly approximately 3-5 mm apart. Each line was extended passed both cortical boundaries to ensure the entire grey matter was sampled. Using the line profile function in MEDx3.2, the line-profiles were recorded to file. The program to analyse these lineprofiles was written in MATLAB 6.0. The line profiles were read in as an array consisting of information about each line profile, namely the starting and finishing voxels, followed by a series of intensity readings.

2. Boundary Determination

This array is fed into a sub-program, “inflex”, which determines the inner and outer grey matter boundaries. The boundaries are found by assuming they occur where there is a maximum change in intensity values between two adjacent points ie inflection points in the line profile or peaks in the first differential of this plot. There will an inflection point at the start and end of each line profile marking each boundary. An approximate first differential is taken of the line profile by calculating differences in intensity values between immediately adjacent points. The boundaries are related to the maximum peaks in this differential at the start and end of the plot. This function finds local maxima by using a moving window to smooth smaller fluctuations finds the midpoint of any plateaus. The size of the window determines the number of distinct local maxima it finds. The maximum peak in the first half of the plot is then set as one boundary and the maximum peak in the second half of the plot as the other. These positions, and their corresponding intensity values for all the line profiles are saved as an array and are the output of the sub-program “inflex”.

3. Lamina Determination

The original array is also fed into a sub-program, “lamfinder”, which determines if any lamination is present, the number of lamina, and various characteristics of the lamination. Lamination is detected by a dip in the intensity profile ie a local peak followed by trough. “Lamfinder” finds the peaks and troughs by finding where the approximated 1st differential crosses zero and where there is a change in sign on either side of this point in the first differential. Again, some smoothing is done to avoid minor non-significant stationary points and to find midpoints of plateaus. Once it has determined the position of the peaks and troughs and their corresponding intensity values, it then calculates:
position of the peak and trough relative to the cortical boundaries as determined from “inflex”.
A measure of the thickness of the lamination (ie difference in position between peak and trough) relative to the cortical thickness.
The intensity drop across the lamination (intensity difference between peak and trough) relative to the intensity drop across the entire grey matter (alternatively, relative to the intensity value at the outer cortical boundary)
Using the output from “inflex”, the sub-program “coord” calculates the actual (x,y) coordinates of the cortical boundaries. These are used for plotting the cortical edge to give graphical representation of the results.
   4. Final Interpretation and Representation

Because even minor dips in intensity are detected by this program, it is necessary to threshold the results before plotting them. The intensity drops across the lamination have been used for this purpose. Discarding any “laminations” where the intensity drop is less than 5% of the total grey matter intensity drop clears a lot of the “noise” out of the results, and specific regions of lamination begin to appear. Higher thresholds yield more localised regions. A number of different aspects of the lamination can be plotted. Over a simple 2D plot of each slice showing one of the cortical edges the position of points of lamination can be plotted. Each point is colour coded to represent the degree of intensity drop found for that lineprofile. Multiple single slice 2D plots can then be stacked to give a 3D plot showing regions of lamination on the cortex. Regions with similar intensity drops can then be identified, as can a gradual change in the intensity drop which may mark a region with poorly defined borders.

Alternatively, using one of the cortical edges as a template, a 3D plot can be generated by projecting up from this the position of the start and finish of lamination found for that lineprofile at that point. This is useful in determining how the position and thickness of the lamination various around a single slice.

Automatic Line Profile Generation and Analysis

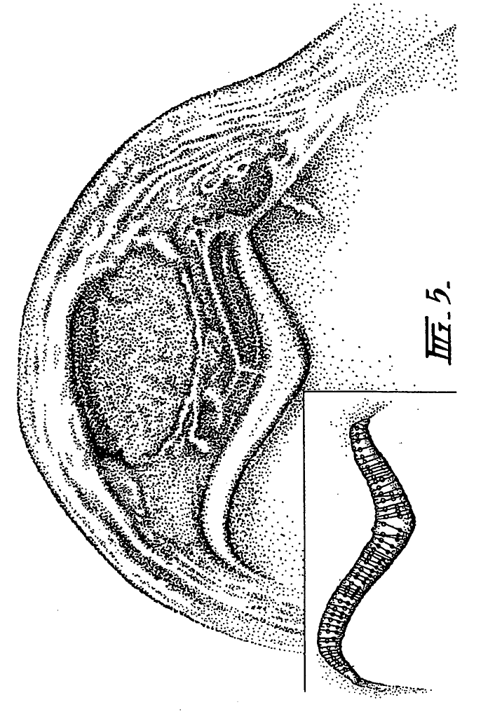

The following will describe an alternative procedure for the generation and analysis of line profiles. This process uses a software rountine which can broadly be divided into two parts: (A) Automatic line profile generation. The operation of the software is now outlined in the context of an analysis of a brain. Line scans that were generated and along which analyses were conducted using this software routine are shown in FIG. 5.

A. Automatic Line Profile Generation (Functions: Getbounds; Skeleton; Skelcontours; Closestpt)

calculate a skeletal representation of the grey matter of a brain (GM) from a segmented image (use distance transform method)
the skeleton allows a set of non-intersecting profiles to be drawn across the GM
these profiles are unevenly spaced and often have many share a single end point
prune these profiles to keep only the shortest whenever they share an end point
interpolate between the pruned profiles to get an even set of non-intersecting profiles

Function: GetBounds
Start with the segmented image, with GM=1, WM=2, CSF/other=0
calls on:

Function: Skeleton
Form a new image such that
   (A) all GM points that border the with matter of a brain (WM) and let them=2
   (B) also-find all GM points that border CSF/other and let them=3
   (C) let all other GM points=1
   (D) and all remaining (non-GM) points=0
Function: Skelcontours
   For all points that=1 in this new image find (using function: closestpt)
      (A) the minimum distance for a point of value 2
      (B) the minimum distance for a point of value 3.
   Whenever the above two distances differ by a small amount (say sqrt (2) in 2D) then that point is marked as a skeleton point and the points of values 2 and 3 that are at the minimal distances-are the end points of the profile.
   Prune this set by only keeping the shortest profile
      out of each set of profiles that share an end point.
         B. Line Profile Analysis (Functions: TwoD; iprofile; IPA; Coord; Stationary; Concavity; Peaks)
         Function: TwoD
   read in the coordinates of the line profiles generated by Getbounds
   user generated input read in
   calls on functions:
      Function: iprofile
   generates interpolated line profiles between the specified coordinates
      Function: IPA
   returns the coordinates of the stationary points of the line profile, widths, relative depth and intensity drops related to the stationary points (using function: stationary; peaks; coord)
   returns the coordinates of the concavity changes of the line profile (using function: concavity; peaks, coord)
   plots the line profiles if required
   Output is user specified results overlaid on original image using data returned: choices of results to view include position, depth, number, width and intensity drop of laminations.

### EXAMPLE 2

### Three-Dimensional Volumetric Automated Cortical Lamination Analysis

[Computer codes referred to throughout this example are listed in the Appendix. An off the shelf function “spm_hread” was used to read in the header information for the image (SPM99, freely available). All computer codes are in MATLAB 6.0].

The 3D analysis builds on the 2D analysis already described. In this example there are five steps in the 3D approach.

1. 3-D Representation of the Brain

As line profiles need to be dropped perpendicularly through the cortex, the surface of the brain needs to be accurately characterised in order to get the correct topography.

The surface was represented as a mesh, using the software package EMSE Suite (Source Signed Imaging, Inc.), although the analysis is not dependent on what program was used to generate the mesh, and can be adapted to use others. EMSE approximates the surface as a mesh made up of triangles.

2. Information (Meshes and Images) are Read in and Normals to Surfaces Calculated

This module needs to read EMSE (or in the future other formats) meshes. It outputs lines along which the profiles need to be generated. Initially it has been agreed that the normals to the faces of the mesh would be calculated. This is due to coding and computational simplicity. The degree of sampling therefore depends on the size of the mesh. As the number of faces is increased, their size decreases and hence the density of the sampling will also increase. Additional normals at vertices, and further interpolation along the edges and/or faces can then be added incrementally so that ultimately, every point on the surface of the cortex can be sample. “Quickrun” is the initiating program, prompting the user to input information and choose analysis preferences. It calls the function “read emse” which reads in the mesh. The functions “tricenter”, “trinormal” and “normalize” then calculate the normals to each triangular face of the mesh through its centre. The function “snc” is then called which generates the line profiles and performs the analysis.

3. Use Normals and Original Analyze Image to Calculate Intensity Line Profiles

This is the function of “snc”. It reads in the image data using “anzload” and, using the normals calculated previously, generates the line profiles. The function “lpa” is then called which performs the actual line profile analysis.

4. Perform Cortical Lamination Analysis on Line Profiles

“Lpa” determines changes in concavity stationary points and boundary points by calling various functions. The function “concavity” finds the changes in concavity along the line profile. These correspond to where the second differential crosses zero. Therefore, it passes the first differential of the line profile to the function “peaks” which then finds the differential of this (ie it uses the second differential in this case). The zero points are found by determining where there is a change in sign along this curve. The function “ ”boundary_pts” then uses the information from “concavity” to determine the cortical boundaries using a vector method which incorporates a number of competing criteria for assigning the cortical boundaries. The function “stationary” determines stationary points in the line profile. These correspond to where the first differential crosses zero. Therefore, “stationary” passes the line profile to “peaks” which then finds the zero points in the first differential in the same way it did for “concavity”. Using all this information, “lpa” then determines a number of features of each line profile such as the number of laminations, their widths and the intensity drops corresponding to each.

All data is thresholded using an intensity change significance threshold and a resolution significance threshold. The former is determined from the signal-to-noise ratio of the original image whilst the latter is determined from the resolution of the original image.

5. Visualisation of Results

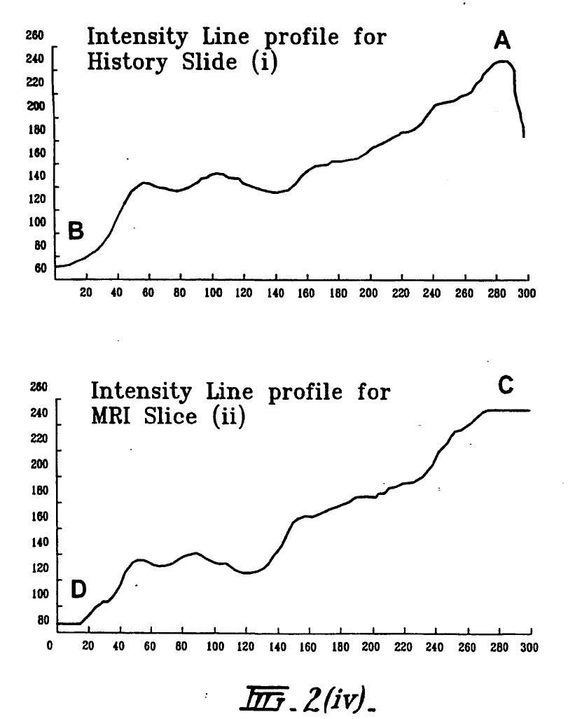

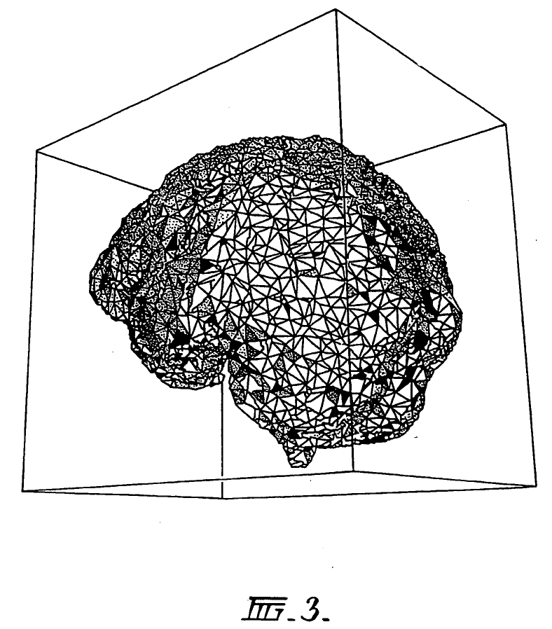

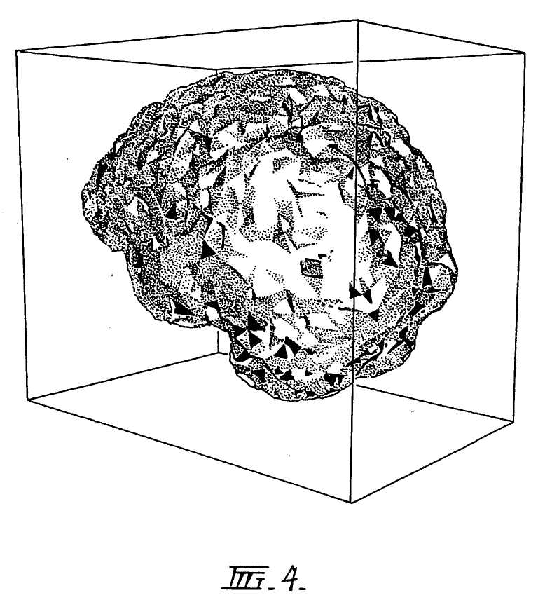

The information from “lpa” is used by “snc” to colour the mesh using the function “colour_picker” according to what results the user wishes to visualize. A colour coded wireframe in OOGL (freeware: suitable for geomview) is generated. OOGL can be easily converted to VRML using available tools. This produces a 3D model which can be rotated and rendered in real time using geomview (freeware). The colour represents a particular analysis result and the intensity of that colour quantitatively reflects the magnitude of that result. Fanother option may involve overlaying the MR and the wireframe and also combining multiple coloured meshes representing various combinations of results. Similarly coloured regions would represent cortical regions sharing a common lamination feature eg, intensity drops, positions of laminae, thicknesses, number of laminae etc. FIG. 3 shows a mesh of two-dimensional forms that approximates the human brain. Darker regions correspond to darker shades of colour and indicate, in this example, lamination. FIG. 4 shows the corresponding three-dimensional visualisation without the mesh.

It will be appreciated that each line profile contains a large amount of information about the cortex through which it passes in the MRI image. In this example it has been chosen to examine one aspect of that by using first and second differentials to determine stationary points and changes in concavity. As the quality and or type of images improves, or even regardless of this, there are many other ways of examining and analysing the information that can be incorporated into this analysis which can aid in defining distinct regions.

It will also be appreciated that this method is not limited to biological objects. The method of mapping the property for the object is not limited to the detection of a mapping the property for a plurality of slices. Alternative methods can be used which may not comprise the detection of slices. It will also be appreciated that the method is not limited to nuclear magnetic resonance imaging. Each of the lines may also be a region. Alternative computer routines may be used to analyze the array of values which may or may not comprise numerical procedures such as differentiation.

It will also be appreciated that a procedure similar to the automatic line profile generation and analysis described in the context of 2-D analysis can be extended to be applicable 3-D analysis.

Although the invention has been described with reference to particular examples, it will be appreciated by those skilled in the art that the invention may be embodied in many other forms.

It is to be understood that, if any prior art publication is referred to herein, such reference does not constitute an admission that the publication forms a part of the common general knowledge in the art, in Australia or any other country.

1. A method of mapping a property of a three dimensional object, said method comprising the steps of
mapping the property for at least a portion of the object,
providing a line or region which defines intersections with part of said mapped portion, and
displaying the property for the intersections.

2. A method of mapping a property of a three dimensional object, said method comprising the steps of
mapping the property for a plurality of slices within the object,
providing a line or region which defines intersections with part of at least some of the plurality of slices, and
displaying the property for the intersections.

3. A method as defined in claim 1 wherein the property relates to nuclear magnetic resonances.

4. A method as defined in claim 2 wherein mapping of the property for the plurality of slices results in a plurality of nuclear magnetic resonance images.

5. A method as defined in claim 1 wherein the line or region is a line.

6. A method as defined in claim 5 wherein the line is a plurality of lines.

7. A method as defined in claim 6 wherein each of the lines is substantially perpendicular to the surface of the three-dimensional object.

8. A method as defined in claim 1 which further comprises the step of approximating the shape of the object by a three dimensional lattice of two-dimensional forms created by a first computer routine.

9. A method as defined in claim 8 wherein the lattice is a mesh.

10. A method as defined in claim 8 wherein each of the lines is a line substantially perpendicular to one of the two-dimensional forms.

11. A method as defined in claim 2 wherein the slices are selected using a second computer routine.

12. A method as defined in claim 3 wherein a third computer routine maps nuclear magnetic resonance values for the intersections by displaying an array of values.

13. A method as defined in claim 12 which further comprises the step of analysing the array of values using a fourth computer routine.

14. A method as defined in claim 13 wherein the fourth computer routine analyses numerical properties.

15. A method as defined in claim 12 wherein the step of analysing the array of values comprises differentiation.

16. A method as defined in claim 15 wherein analysing the array of values comprises determining the positions of the maxima, minima and/or zero-points of the array of values and the derivatives of the array of values.

17. A map produced by a method of mapping a property of a three dimensional object, said method comprising the steps of
mapping the property for at least a portion of the object,
providing a line or region which defines intersections with part of said mapped portion, and
displaying the property for the intersections.

18. A map produced by a method of mapping a property of a three dimensional object, said method comprising the steps of
mapping the property for a plurality of slices within the object,
providing a line or region which defines intersections with part of at least some of the plurality of slices, and
displaying the property for the intersections.

19. A method of mapping a property of an object, said method comprising the steps of
mapping the property for a slice within the object,
providing a line within the slice, and
displaying the property for the line.

20. A method as defined in claim 19 wherein the property wherein relates to nuclear magnetic resonances.

21. A method as defined in claim 19 wherein mapping of the property for the slice results in a nuclear magnetic resonance image.

22. A method as defined in claim 19, wherein the line is a plurality of lines.

23. A method as defined in claim 19 wherein a fifth computer routine maps nuclear magnetic resonance values for the intersections by displaying an array of values.

24. A method as defined in claim 23 which further comprises the step of analysing the array of values using a sixth computer routine.

25. A method as defined in claim 24 wherein the fifth computer routine analyses numerical properties.

26. A method as defined in claim 23 wherein the step of analysing the array of values comprises differentiation.

27. A method as defined in claim 26 wherein the step of analysing the array of values comprises determining the positions of the maxima, minima and/or zero-points of the array of values and the derivatives of the array of values.

28. A map produced by a method of mapping a property of an object, said method comprising the steps of
mapping the property for a slice within the object,
providing a line within the slice, and
displaying the property for the line.
